(19) United States
(12) Patent Application Publication
(10) Pub. No.: US 2004/0055700 A1
(43) Pub. Date: Mar. 25, 2004

(54) Carpet seaming iron and method

(75) Inventors: James M. Carroll, Livermore, CA (US); Robert T. Zajdel, Castro Valley, CA (US)

Correspondence Address: BRIAN M BERLINER, ESQ, O'MELVENY & MYERS, LLP, 400 SOUTH HOPE STREET, LOS ANGELES, CA, 90071-2899, US

(73) Assignee: ORCON CORPORATION

(21) Appl. No.: 10/620,936

(22) Filed: Jul. 16, 2003

Related U.S. Application Data
(60) Provisional application No. 60/396,921, filed on Jul. 16, 2002.

(51) Int. Cl. B32B 31/00; B30B 5/04; C09J 1/00

(52) U.S. Cl. 156/275.1; 156/275.3; 156/304.3; 156/304.4; 156/580; 156/579; 156/583.1

(57) ABSTRACT

A carpet seaming iron includes a platen, a heating element conductively coupled to the platen, and a passageway interposed between the platen and handle. The passageway is configured to accommodate a piece of seaming tape over the platen and under the handle of the seaming iron. The handle is designed to protrude between adjacent pieces of carpet that are to be seamed together. The seaming iron may be used to make a seam using a seaming tape having thermal adhesive on an upper side, by heating the seaming tape from below. Advantageously, a seam may be completed without contact between the thermal adhesive of the seaming tape and the platen of the seaming iron.

### CROSS-REFERENCE TO RELATED APPLICATION

This application claims priority pursuant to 35 U.S.C. § 119(e) to U.S. Provisional Application No. 60/396,921, filed Jul. 16, 2002, which application is specifically incorporated herein, in its entirety, by reference.

### BACKGROUND OF THE INVENTION

1. Field of the Invention

The present invention relates to methods for seaming of carpeting and like materials using thermoplastic adhesive seaming tape, and to tools for activating carpet seaming tape.

2. Description of Related Art

In the installation of carpeting materials for the construction trades, it has become a common practice to seam join along abutting edges) adjacent pieces of carpeting together using an adhesive tape that is run along the seam line. The adhesive tape comprises a reinforcement scrim for spanning the seam line together with an adhesive for bonding the scrim to the back layer of the adjoining carpet pieces. Many tapes also include a backing layer of paper or like material to prevent the adhesive from sticking to the floor under the tape.

Most adhesive tapes employ a thermoplastic, hot-melt adhesive for bonding the scrim to the carpet backing. The adhesive is activated by heating, usually with a heating iron such as generally described in U.S. Pat. No. 4,536,244 (Greci, et al.) FIG. 1 shows an exemplary prior-art carpet seaming iron 20 used for seaming adjoining pieces of carpet 30 together. Prior-art iron 20 has a lower heated platen 22 that is connected to a handle 26 by a blade-like handle support 27, which is in turn connected to a heat shield 24 that may be mounted to platen 22 and insulated from it by an insulating gasket 23 and other interior insulating materials (not shown). Electric power may be supplied via a cord 28.

Seaming iron 20 is operated to direct heat onto the adhesive 40 of adhesive tape 34. Tape 34 is placed between the floor 32 (which may be covered by a cushioning pad or other covering) and carpet 30, with the adhesive 40 facing the back of the carpet. Scrim 38 may be in or below adhesive 40, and a backing paper 36 may be underneath both the scrim and the adhesive.

To make the seam, an operator gradually moves the iron 20 along tape 34, melting the adhesive 40. Shield 24 protects the carpet 30 from being damaged by heat from the platen 22 as the seaming iron is moved underneath the carpet. At the back of the iron (not shown), the operator presses the carpet backing into the molten adhesive, and holds the carpet in place until the adhesive cools.

The prior-art seaming method as just described is well-proven in practice, but suffers from some limitations. One limitation is that it is relatively difficult to deposit adhesive between the vertical abutting edges 31 of the carpet backing using the method. Bonding of the vertical abutting edges together is desirable, to strengthen the seam, prevent carpet tufts from falling out of the backing, and to bring the centroid of the seam bond closer to the carpet backing, thereby reducing the bulging (“peaking”) of the seam that is sometimes apparent when the carpet is placed into tension transverse to the seam line. A central groove 21 or other channeling feature is sometimes placed in platen 22 to help direct adhesive between edges 31, but it can be difficult to meter a proper amount of adhesive onto the edges 31 while performing the other tasks required to finish a seam. Adhesive is sometimes placed directly along edges 31 using a separate adhesive spreading tool, but this requires an additional step.

A further limitation of such prior art methods is that additional effort is required to align the adhesive tape with the carpet seam, because there is no positive alignment between the adhesive tape and the seaming iron. This additional effort may distract the operator from moving the seaming iron at a constant, well-paced speed and from forming a proper bond using the molten adhesive. Also, to compensate for the possibility of misalignment, adhesive tapes may be somewhat wider than is needed for optimal seam strength.

Yet another limitation of prior art seaming irons is that direct contact between the hot platen 22 and the hot-melt adhesive can lead to undesirable buildup of adhesive on the platen. Such adhesive build-up may cause problems if it is driven into the interior of the iron, such as by failure of gasket 23. The build-up may also leave undesirable residue on other objects when the seaming iron is set aside after a seam is completed, or may become overheated and generate undesirable smoke or fumes when the iron is idled.

It is desirable, therefore, to provide a seaming iron and method that overcomes the limitations of the prior art.

### SUMMARY OF THE INVENTION

The present invention provides a carpet seaming iron that prevents direct contact between the adhesive of an adhesive tape and the iron platen, provides for positive alignment between the adhesive tape and the seam line, and facilitates placement of molten adhesive on the abutting vertical edges of the seam. The iron is relatively inexpensive to build and operate, and easy to use. Proper use of the iron according to the method of the invention may eliminate adhesive build-up on the seaming iron, allow for perfect alignment of the seaming tape with the seam, and conveniently ensure that adhesive will be placed in optimal locations in the seam.

The seaming iron according to the invention comprises a heated platen that is placed underneath the adhesive tape; not on top of it as with prior-art seaming irons. The seaming iron further comprises a bridge that connects the platen to a handle. A passageway is defined between the bridge and the platen, through which the adhesive tape may pass through and be disposed over the heated platen. The platen is designed to heat the adhesive through the backing of the tape, so no adhesive need contact the hot platen. Sidewalls of the bridge, or other guide features, may be used to direct the adhesive tape over the platen and along the seam line. A handle may be attached to the bridge by a blade-like support that permits the seaming iron to easily pass between abutting pieces of carpet. An insulating layer may be placed under the platen to protect the floor from the heat of the platen.

To use the new seaming iron, it may be drawn along the seam between abutting edges of the carpet in a manner similar to prior-art seaming irons. The adhesive tape is threaded between the bridge and the platen, and passes over the top of the platen, thereby melting the adhesive on the tape. The carpet passes over the bridge and may be pressed down into the adhesive near the rear of the platen. The rear, trailing end of the platen may be maintained at a relatively cool temperature compared to the forward section of the platen, so as to not overheat the carpet backing. In the alternative, the carpet may be pressed into the adhesive after the tape has cleared the trailing edge of the platen.

In an embodiment of the invention, the upper surface of the heated platen is crowned or contoured so as to bring the abutting carpet pieces together through a layer of molten adhesive as the seaming iron is drawn forward. The contour of the platen may be configured so that an optimal amount of adhesive is deposited between the vertical abutting edges of the carpet during this process. The platen may further be tapered to a thin trailing edge, to guide the seamed carpet back onto the floor.

A more complete understanding of the carpet seaming iron and method will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

In general, the drawings are intended to illustrate the concepts of the invention in a schematic fashion. It should be appreciated that the drawings do not reflect or limit actual physical embodiments with respect to engineering and design details. The drawing scale is generally arbitrary. Particularly with respect to FIGS. 1-3 and 9-12, the vertical drawing scale has been exaggerated somewhat to better illustrate the concepts of the invention. One of ordinary skill in the design of carpet seaming tools will understand appropriate sizes for components of seaming irons according to the invention, without needing to review scaled drawings.

FIG. 1 is a front elevation view of a prior-art seaming iron during seaming of carpeting materials.

FIG. 2 is a front elevation view of an exemplary seaming iron according to the invention during seaming of carpeting materials.

FIG. 3 is a side view of an exemplary seaming iron according to the invention during seaming of carpeting materials.

FIG. 4 is a perspective view of an exemplary heating platen for use with a seaming iron according to the invention.

FIG. 5 is a rear elevation view of an exemplary seaming iron according to the invention.

FIG. 6 is a front elevation of an exemplary heating platen with a crown having zero curvature.

FIG. 7 is a front elevation an exemplary heating platen with a crown having negative curvature.

FIG. 8 is a side elevation an exemplary heating platen, showing a taper from the leading edge to the trailing edge.

FIG. 9 is a side elevation view of an exemplary seaming iron with a crowned heating platen during seaming of carpeting materials.

FIGS. 10-12 are cross-sectional views taken at the successive sections 11-12 of FIG. 9, respectively, showing operation of a method for applying adhesive to edges of carpet backing using a crowned iron.

FIG. 13 is a flow diagram showing exemplary steps of a method according to the invention.

### DETAILED DESCRIPTION OF THE PREFERRED EMBODIMENT

The present invention provides a novel carpet seaming iron, and method of using it, that overcomes the limitations of the prior art. In the detailed description that follows, like element numerals are used to identify like elements that appear in one or more of the drawings.

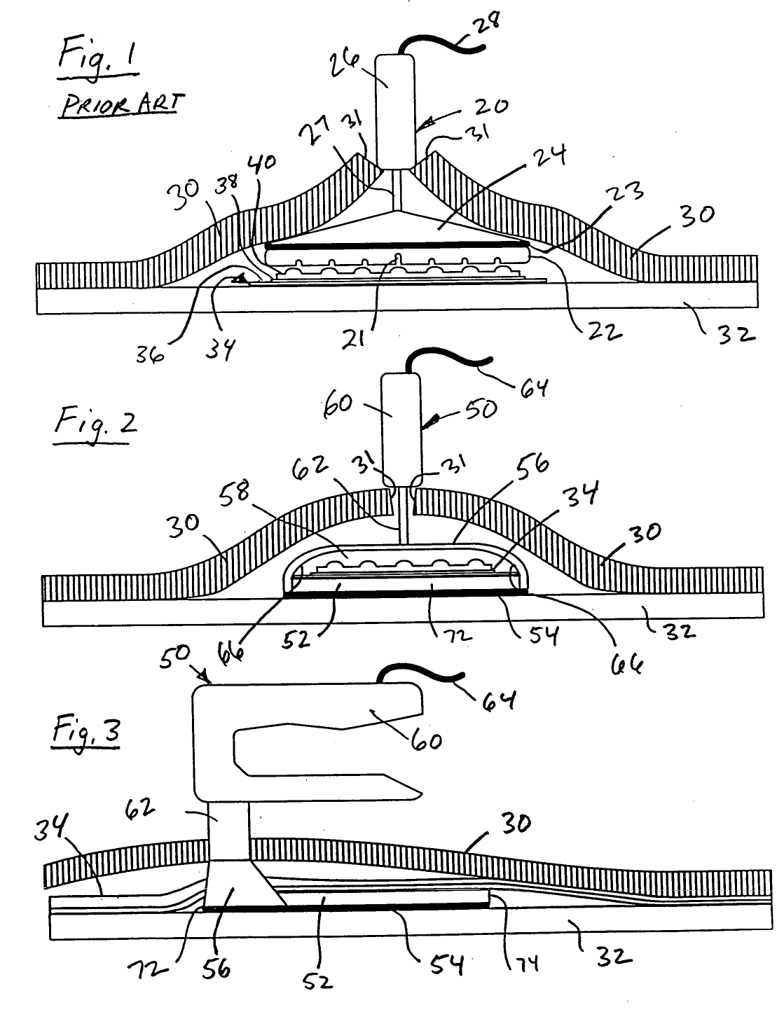

Referring to FIGS. 2 and 3, an exemplary seaming iron 50 is shown relative to pieces of carpet 30 that are to be seamed together with adhesive tape 34. The various elements of iron 50 are shown in a generally schematic, simplified fashion, and the particular shapes depicted are not intended to limit the inventive concept of the iron. Rather, FIGS. 2 and 3 are intended to depict an exemplary overall arrangement and combination of elements of a seaming iron, based on which one of ordinary skill could develop various different engineering designs for the manufacture of irons. In like manner, a seaming iron according to the invention may be constructed using any of the well-known materials currently used for seaming irons, or any other suitable materials. Suitable materials, components, and devices for a particular seaming iron will be evident to one of ordinary skill, without needing information more detailed than the general information provided herein.

Similarly to a conventional iron, seaming iron 50 is placed under the carpet 30 and over the floor material 32, with a blade-like handle support 62 supporting the handle 60 between the abutting edges 31 of the carpet. The similarity ends there, however, because seaming iron 50 is not placed on top of adhesive tape 34. Instead, tape 34 is threaded through passageway 58 formed between bridge 56 and platen 52, and over the top surface of the platen. Platen 52 is heated, such as by an electric current that may be supplied through cord 64. Insulator 54 may cover the bottom surface of platen 52, to protect floor 32 from the platen heat. It may be advantageous to include an air gap (not shown) between platen 52 and insulator 54. Handle 60 may be a plastic or other non-conductive piece for gripping by an operator and for housing wiring, controls, indicators, and the like.

The iron 50 is operated by pushing it forward between the abutting edges 31 of carpet 30. Prior to beginning the seam, a length of adhesive tape 34 is laid out under edges 31, and the tape 34 is threaded through the passageway 58 at one end. In FIG. 2, the forward or leading end of the iron is indicated by the numeral 72, and the trailing end is indicated by 74. The platen is heated to above the melting point of the adhesive on tape 34, and thus, the adhesive is heated from below as it passes over platen 52.

In an embodiment of the invention, the platen is configured so that the tape adhesive is substantially melted as it passes through passageway 58. It may be necessary to make passageway 58 somewhat longer, such as by making bridge 56 extend further back towards the trailing end 74, to ensure complete melting. In this embodiment, the section of the platen behind the bridge (i.e., between the bridge and the trailing edge 74) may be maintained at a relatively cool temperature. The temperature in this zone may be warm enough to maintain the adhesive in a softened state, but not so warm so as to damage the carpet backing. In the alternative, essentially all of platen may be maintained at a temperature that is high enough to melt the adhesive after the tape has passed over the entire length of the platen. In such case, the carpet may be held away from the platen until near trailing edge 74, as shown in FIG. 3. An insulating support or supports (not shown) may be mounted on or over platen 52 to hold it away from carpet 30. The carpet passes over bridge 56, which also serves to protect it from the hot platen.

Sidewalls 66 of bridge 56 may be used to align tape 34 with passageway 58. Likewise, bridge 56 is aligned relative to the seam by the blade-like handle support 62. Hence, alignment of tape 34 with the seam is ensured. In lieu of sidewalls 66, any suitable alignment tabs, channels, rollers, or like elements, may be provided in bridge 56 and/or platen 52, for alignment of tape 34.

It may be desirable to make the length of the bridge adjustable to accommodate different types of adhesive tape or carpet. For example, when working with a carpet that is especially heat-sensitive, it may be desirable to make the bridge longer. Such adjustability may be provided by a telescoping-type of mechanism, by additional panels that may be attached to, or removed from, the top of the iron platen as desired, by a movable bridge, or by any other suitable method. A movable bridge is one that can be moved backwards or forwards along the length of the platen, and locked in a desired position. By moving the bridge back towards the trailing edge, contact between the carpet and the platen may be delayed. Conversely, when a movable bridge is in a more forward position, contact time with the platen may be increased, and an “excess” portion of the bridge may overhang the leading edge of the platen.

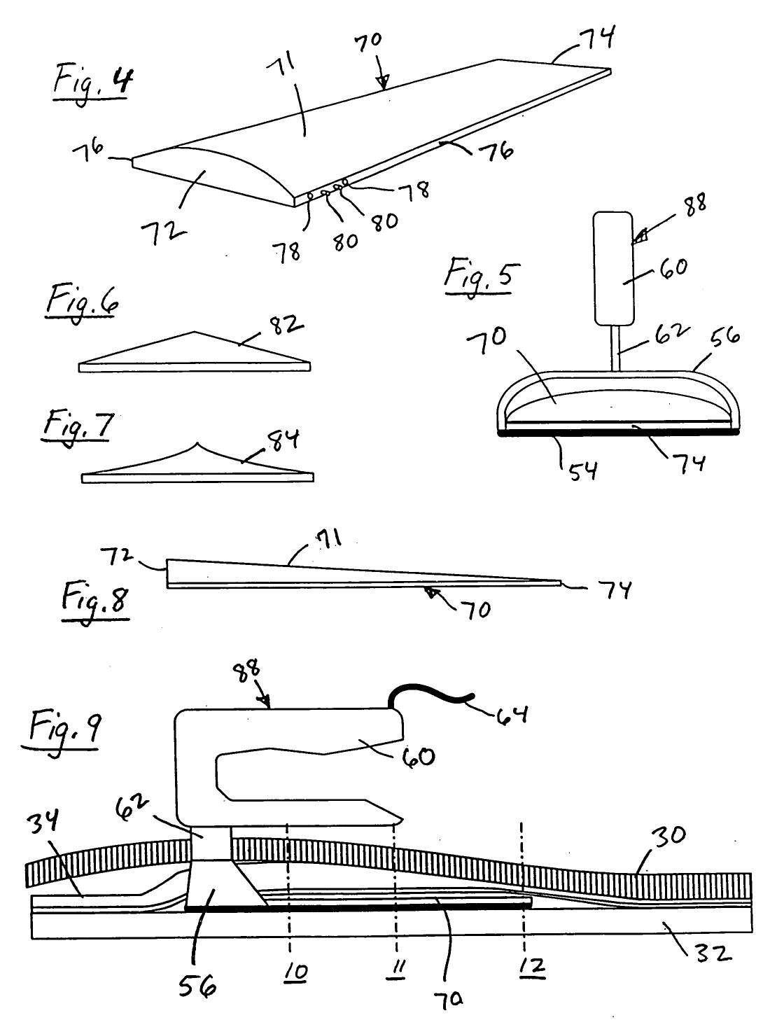

In an embodiment of the invention, the platen is an essentially flat, rectangular piece, such as shown in FIGS. 2 and 3. In other embodiments, the platen may be provided with a crowned or contoured upper surface, as shown in FIG. 4. Of course, other surfaces of the platen, such as the lower surface or side surfaces, may be contoured for various reasons, but the invention does not concern such details. Rather, it is the contouring of the upper surface that represents an especially innovative variation of the invention, because of the significant and surprising benefits provided thereby.

As shown in FIG. 4, one suitable crowned configuration for a crowned platen 70 comprises an upper surface 71 with a convex curvature at a leading edge 72, tapering to a relatively flat and thin trailing edge 74. Side edges 76 may have a uniform height as shown, or in the alternative, may be tapered so as to be thinner towards the trailing edge, or blended entirely with the upper surface 71. Side edges 76 may provide flat surfaces, or other mounting surfaces, for mounting the platen to a suitable bridge and/or connecting electrical wiring. For example, and not by way of limitation, side edges 76 may be provided with mounting holes 78 for threaded fasteners or the like, and/or pins 80 for making electrical connections. Platen 70 may be attached to a bridge 56 and handle 60 of an iron 88, as shown in FIG. 5. In the alternative, the platen may be provided with wing-like projecting tabs to which a bridge may be attached, or a bridge may be fastened to the top of the platen near its side edges, or to the bottom of the platen. In lieu of a bolted connection, the platen may be attached to the bridge using a hinging connector in opposition to a latch, or by any other suitable connector. A hinged connector provides the advantage of allowing the bridge assembly to be opened for placement of the tape, or for cleaning. An insulating layer 54 may be provided under platen 70, optionally separated from platen 70 by an air gap (not shown).

Instead of a convex curvature, the upper surface of a crowned platen 82 may be raised, yet have zero curvature, as shown in FIG. 6. It may even be suitable to provide a crowned platen 84 with a negative, convex curvature, as shown in FIG. 7. Whatever the curvature of the platen upper surface, it is preferable for the platen to be tapered from a relatively thick section towards its leading edge 72 to a relatively thin section towards its trailing edge 74, as shown in FIG. 8. The thickest portion of platen 70 may be at the leading edge 72, as shown. In the alternative, the thickest (i.e., highest point of the crown) may be located at a position somewhat behind the leading edge, if desired. It is believed preferable for the platen to taper to its thinnest at the trailing edge 74, but the invention is not limited thereby. For making symmetrical seams, the platen should be essentially symmetrical across its side edges with the highest part of its crown along an longitudinal central axis along the length of upper surface 71.

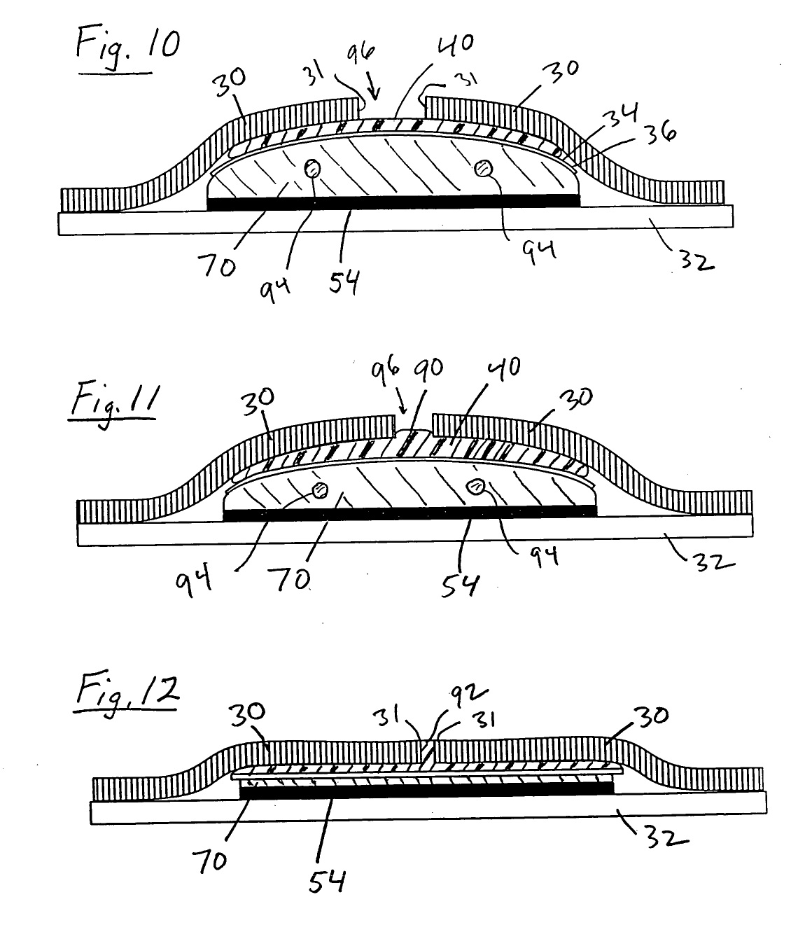

A side view of an exemplary iron 88 with a crowned platen 70 during a seaming operation is shown in FIG. 9. Seaming iron 88 may be compared to iron 50, having a flat platen 52, shown in FIG. 3. With reference to FIG. 9, tape 34 is threaded between a bridge 56 and the platen 70 of iron 88. Tape 34 is bowed upwards and outwards by platen 70, following the contour of its upper surface. Carpet 30 passes over bridge 56 and contacts the adhesive tape 34 at a position behind bridge 56 where the crowned upper surface of the platen is at or near its maximum height, indicated as section 10 of FIG. 9. Carpet 30 may remain in contact with adhesive tape 34, which, in turn, remains in contact with platen 70, from the point of first contact to the trailing edge 74. By the time the carpet reaches the trailing edge, it may be bonded to tape 34 and require no further setting. In the alternative, the adhesive may remain melted or softened at the trailing edge, and pressure may be maintained to hold the carpet and tape in position while the adhesive cools and hardens. In either case, it should be appreciated that platen 70 is preferably configured so as to not be excessively hot rearward of the point of first contact between the adhesive tape and the carpet, both to avoid damaging the carpet 30 and perhaps also to permit an operator to manipulate the carpet in this area.

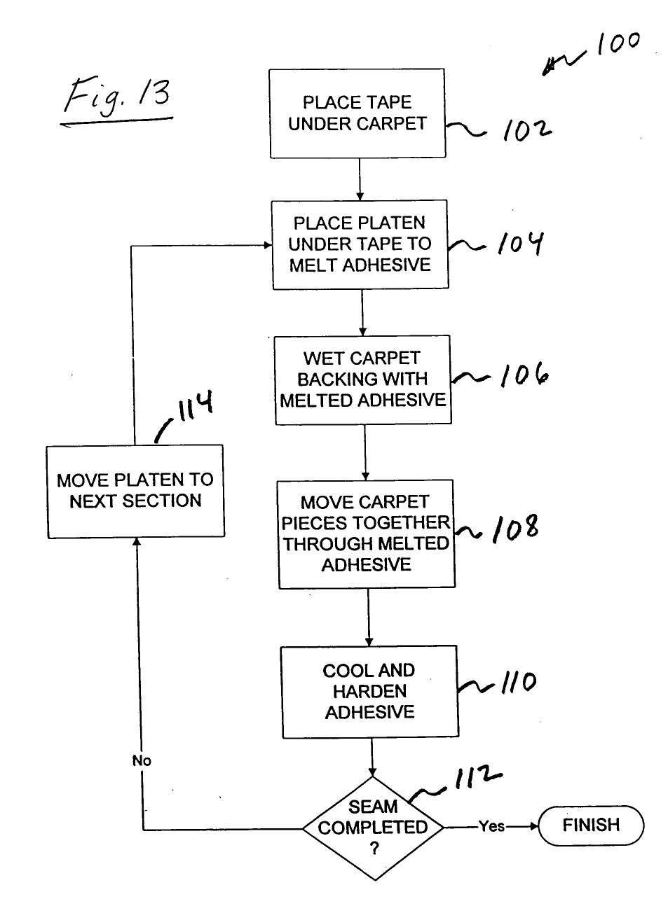

The operation and benefits of crowned iron 88 are more apparent from inspection of FIGS. 10-12, which show a sequence of cross-sectional views taken as sections 11-12 of FIG. 9, respectively. The sequence of views demonstrates how the crowned platen 70 may be used to efficiently create a seam with an optimal edge weld. At section 10, carpet 30 first contacts adhesive 40 of tape 34. Platen 70 may be relatively thick at this section, thereby presenting a curved upper surface that, consistent with elementary principles of geometry, is substantially longer than a straight line between the side edges. Because of this curvature of the platen's upper surface, a gap 96 is present between the opposing pieces of carpet 30, through which adhesive 40 is exposed.

By way of example, tubular heating element 94 is shown embedded in platen 70, but it should be appreciated that any manner of heating plating 70 may be provided. For example, a relatively flat foil element heat may be used as an alternative to a tubular heater. Different temperature zones may also be provided along the length of the platen, by changing the spacing of heating elements along the length of the heater, using a heating element with different power dissipation in different zones, or by any other suitable method. In particular, as described above, it may be desirable to provide a lower temperature zone towards the trailing edge of the iron. For example, it may be preferable to not heat platen 70 near or behind section 10, in which case element 94, or other heating elements, should be omitted towards the trailing edge. Heating in the region would then rely on conduction of heat from a forward section of the iron.

At section 11, platen 70 is thinner than at section 10 because of the platen's rearward taper. The edge-to-edge length of the platen's upper surface is accordingly less than at section 10, as shown in FIG. 11. Gap 96 is therefore smaller than at section 10, as the opposing carpet pieces converge towards the center of platen 70. As the carpet pieces converge, they scrape a portion of the exposed adhesive 40 towards the center of the platen, creating a bulge 90. This converging of the carpet pieces continues as the carpet travels down the rearward taper of the platen, building the adhesive bulge between the carpet pieces.

At section 12, platen 70 is essentially flat and the carpet pieces have fully converged. The adhesive bulge is now configured to become an adhesive weld between the opposing vertical carpet edges 31, as shown in FIG. 12. The adhesive may be cooled and hardened in this position to create a seam with an optimal edge weld 92. It should be appreciated that an optimal weld 92 will most likely not actually extend through the entire thickness of the carpet 30, as shown in FIG. 12. Instead, an optimal weld will most likely extend through and perhaps slightly beyond the carpet backing only, leaving the carpet tufts essentially free of adhesive. The weld 92 is depicted as shown in FIG. 12 merely for illustrative simplicity.

In summary therefore and with reference to FIG. 13, the present invention provides a method 100 for seaming a carpet using a heated platen that underlies a hot-melt adhesive tape. Method 100 comprises the following steps. At step 102, a length of adhesive tape is placed under abutting edges of carpet to be seamed and on top of a floor. The adhesive tape comprises a layer of hot-melt adhesive over a backing layer, and is oriented with its adhesive layer facing the lower surface of the carpet. At step 104, a heated platen is placed between the floor and the seaming tape. The seaming tape may be threaded over the platen through a bridge, or a bridge may be opened up to allow placement of the tape over the platen. The platen is heated to a temperature sufficiently high to melt the tape's adhesive layer through the backing layer. At step 106, the carpet backing is wetted with the melted adhesive layer of the tape. At optional step 108, the opposing carpet pieces are moved towards each other through the layer of melted adhesive, thereby collecting adhesive between the opposing pieces of carpet, until the carpet pieces abut one another and adhesive wets the opposing vertical edges of the carpet backing. At step 110, the adhesive is cooled and hardened with the adhesive tape held in place against the carpet to complete the seam. At step 114, the platen is moved forward to the next section of seam, while drawing the adhesive tape over the heated platen. Steps 104-114 may be repeated in sequence, until the seam is completed as determined at step 112.

Having thus described a preferred embodiment of a carpet seaming iron and method, it should be apparent to those skilled in the art that certain advantages of the within system have been achieved. It should also be appreciated that various modifications, adaptations, and alternative embodiments thereof may be made within the scope and spirit of the present invention. For example, applications for seaming carpets have been illustrated, but it should be apparent that the inventive concepts described above would be equally applicable to seaming other sheet materials. In addition, various refinements may be made to the embodiments described herein, including but not limited to: making the bridge of the iron longer, so as to cover a more substantial portion of the platen; constructing the platen to have at least two zones, a hotter forward zone for melting adhesive and a cooler trailing zone for acting as a seaming mandrel on which the carpet is placed; providing rollers or other guide features to guide the adhesive tape through the iron; providing electronic controls for the iron; and controlling the platen temperature using one or more temperature sensors for detecting the temperature of the upper surface of the platen or of the molten adhesive. The invention is defined by the following claims.

What is claimed is:

1. A seaming iron for use with thermally-activated seaming tapes, the seaming iron comprising:
a thermally conductive platen having a leading edge, a trailing edge, an upper surface, and a bottom surface;
a heating element in thermally conductive contact with the platen;
a bridge connected to the platen, configured to provide a passageway between the upper surface of the platen and an undersurface of the bridge, the passageway large enough to permit a length of seaming tape to be drawn lengthwise through the passageway over the platen; and
a handle connected to the bridge, the handle extending above the passageway away from the platen.

2. The seaming iron of claim 1, further comprising a blade-like support comprising a connection between the handle and the bridge.

3. The seaming iron of claim 2, wherein the blade-like support is oriented along a central longitudinal axis of the platen.

4. The seaming iron of claim 1, further comprising a thermal insulating material covering at least a substantial portion of the bottom surface of the platen.

5. The seaming iron of claim 4, wherein the thermal insulating material is spaced apart from the bottom surface of the platen.

6. The seaming iron of claim 1, wherein the handle comprises a thermally non-conductive material.

7. The seaming iron of claim 1, wherein the bridge comprises a portion that is movable in a direction along a longitudinal axis of the platen.

8. The seaming iron of claim 1, wherein the upper surface of the platen is substantially flat.

9. The seaming iron of claim 1, wherein the bottom surface of the platen is substantially flat.

10. The seaming iron of claim 1, wherein the platen is tapered to a minimum thickness adjacent to its trailing edge.

11. The seaming iron of claim 1, wherein the upper surface of the platen has a generally convex curvature.

12. The seaming iron of claim 11, wherein upper surface of the platen is shaped progressively flatter towards the trailing edge.

13. The seaming iron of claim 1, wherein the upper surface of the platen has a generally concave curvature on opposite sides of a ridge running along a central longitudinal axis of the platen.

14. The seaming iron of claim 1, further comprising an electrical connector adjacent to a side of the platen, for connecting the heating element to a source of electrical power.

15. The seaming iron of claim 1, wherein the bridge further comprises parallel sidewalls spaced a distance apart, the distance approximately equal to a maximum width of the seaming tape.

16. The seaming iron of claim 1, further comprising a friction-reducing coating disposed on the upper surface of the platen.

17. The seaming iron of claim 1, further comprising a temperature sensor connected to the platen and configured to measure a temperature of the platen.

18. A method for seaming adjacent pieces of carpet using a thermally-activated seaming tape having a thermal adhesive on an upper side of the tape, and a seaming iron having a passageway interposed between a handle and a heated platen, the method comprising:
positioning the platen and passageway of the seaming iron on a supporting surface underneath the adjacent pieces of carpet, with the handle protruding between and above the adjacent pieces of carpet;
positioning the seaming tape in the passageway in contact with the platen, with the upper side of the tape facing a backing of each of the pieces of carpet and facing away from the platen;
heating the platen so as to melt the thermal adhesive on the seaming tape at a molten portion;
positioning the carpet together with the backing of each of the adjacent pieces of carpet in the molten portion of the seaming tape; and
moving the seaming iron forward between the adjacent pieces of carpet away from the molten portion, thereby cooling the thermal adhesive to harden it and to fix the seaming tape to the backing of each of the adjacent pieces of carpet.

19. The method of claim 18, wherein the third positioning step further comprises gathering molten adhesive along an edge of each of the adjacent pieces of carpet by moving the adjacent pieces of carpet together while in the molten portion of seaming tape.

20. The method of claim 19, further comprising cooling the gathered molten adhesive to harden it and fix it to adjoining butted edges of the backing of each of the adjacent pieces of carpet.
